(19) United States
(12) Patent Application Publication
(10) Pub. No.: US 2016/0223082 A1
(43) Pub. Date: Aug. 4, 2016

(54) Parking Lock for Motor Vehicles

(71) Applicant: Bayerische Motoren Werke Aktiengesellschaft, Muenchen (DE)

(72) Inventors: Peter STRENG, Emmering (DE); Michael HOMBAUER, Harthausen (DE); Tobias HERTTER, Muenchen (DE)

(21) Appl. No.: 15/094,363

(22) Filed: Apr. 8, 2016

Related U.S. Application Data
(63) Continuation of application No. PCT/EP2014/069847, filed on Sep. 18, 2014.

(30) Foreign Application Priority Data
Oct. 10, 2013 (DE) 10 2013 220 396.9

(51) Int. Cl. F16H 63/34

(52) U.S. Cl. CPC F16H 63/3433

(57) ABSTRACT

A parking lock for motor vehicles includes an activation device with a shaft for coupling to an actuator. The shaft is pivotable about an activation axis between an activation position and a release position. A latching system is coupled to the activation device and has a latch pivotable about the activation axis between a latching position and an unlatching position. A pawl is pivotable about a pawl bearing axis between a locking position and a release position, and a parking lock gearwheel is rotatable about a parking lock axis and coupled to a motor vehicle wheel. The parking lock additionally has at least one of the following features: an axial end of the shaft is designed as a multi-toothed or polygonal element for form-fittingly engaging the actuator; a leaf spring and a ratchet element secured to the shaft for conjoint rotation therewith are provided, the leaf spring and the ratchet element forming a ratchet connection both in the actuation position and in the release position of the shaft; the parking lock gearwheel has teeth and tooth spaces that alternate in the circumferential direction, the teeth having a saddleback-shaped head contour; the latch and/or the pawl have at least one recess, in order to reduce the moment of inertia; and the latch and the pawl co-operate in the latching position of the latch such that a self-locking effect is created between the latch and the pawl.

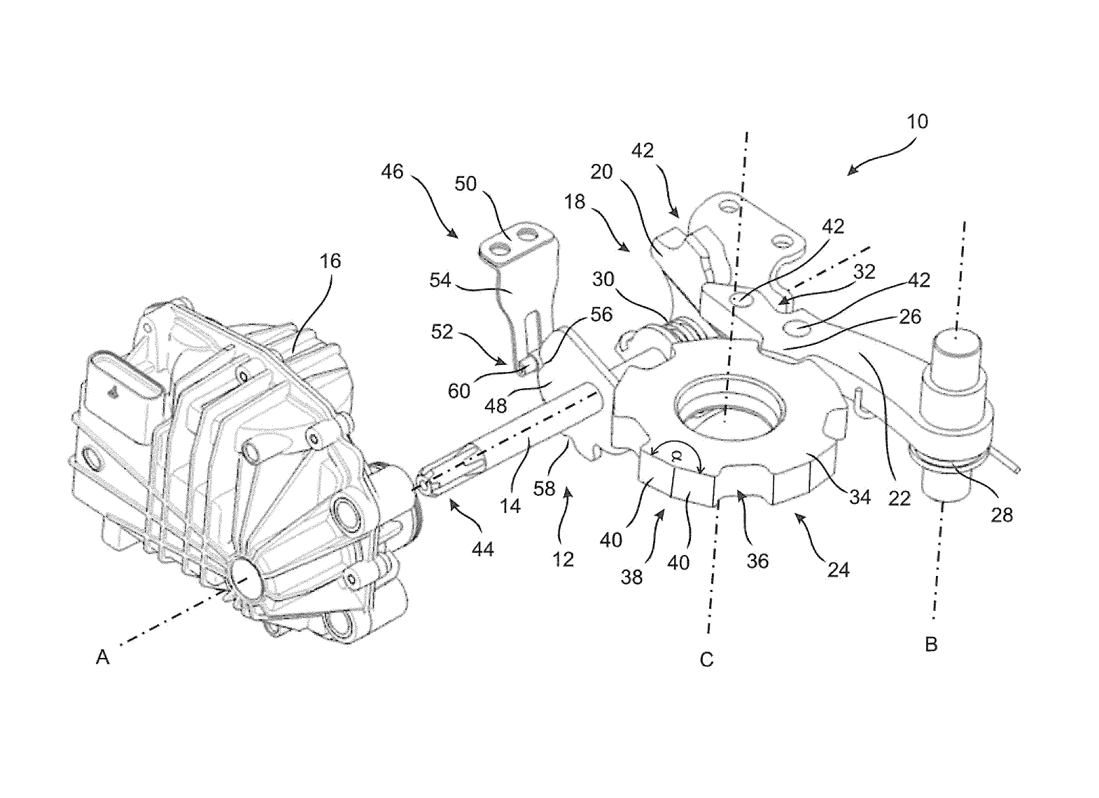

### CROSS REFERENCE TO RELATED APPLICATIONS

This application is a continuation of PCT International Application No. PCT/EP2014/069847, filed Sep. 18, 2014, which claims priority under 35 U.S.C. §119 from German Patent Application No. 10 2013 220 396.9, filed Oct. 10, 2013, the entire disclosures of which are herein expressly incorporated by reference.

### BACKGROUND AND SUMMARY OF THE INVENTION

The invention relates to a parking lock for motor vehicles, in particular for motor vehicles which have an automatic transmission, an automated transmission or an electric drive. In particular, the invention relates to a parking lock having an activation device with a shaft for coupling to an actuator, wherein the shaft can be pivoted about an activation axis between an activation position and a release position. A latching device is coupled to the activation device and has a latch which is pivotable about the activation axis between a latching position and an unlatching position. A pawl is pivotable about a pawl bearing axis between a locking position and a release position, and a parking lock gearwheel is rotatable about a parking lock axis and is coupled to a motor vehicle wheel. In its locking position, the pawl engages in the parking lock gearwheel in such a way that rotation of the parking lock gearwheel about the parking lock axis is blocked, and in its release position, the pawl is spaced apart from the parking lock gearwheel. The result is that rotation of the parking lock gearwheel about the parking lock axis is released. In its activation position, the shaft of the activation device pushes the latch into its latching position, and the latch pushes the pawl into its locking position. And, in the release position of the shaft, the latch assumes its unlatching position in which the pawl is released.

Such a parking lock for motor vehicles of the generic type is already known from DE 10 2010 027 826 A1, and provides the advantage, owing to the few individual parts and the small number of elements which can be moved relative to one another, in particular the latching device, that it has a comparatively low fabrication complexity and wear. This permits a long service life of the parking lock together with reliable functioning. In addition, the latch of the latching device requires only a small amount of space for itself and for its pivoting movement, resulting in a particularly compact design.

On the other hand, the mounting of the actuator on the activation device and the high level of loading of the actuator when the parking lock is activated prove problematic. Furthermore, in the case of misuse, that is to say when the parking lock is engaged when in travel, undesirably strong vibrations occur in the drive train, and the parking lock is damaged. In addition, it has become apparent that a vehicle on a slope is not reliably prevented from rolling away by the above-described parking lock.

Therefore, the object of the invention is to provide a parking lock in which one or more of the described disadvantages from the prior art are eliminated.

According to the invention, this and other objects are achieved by a parking lock of the type mentioned at the beginning, which additionally has at least one of the following features:

(i) an axial end of the shaft is designed to connect in a positively locking fashion to the actuator as a multi-toothed or polygonal element;

(ii) a leaf spring and a ratchet element which is connected to the shaft in a rotationally fixed fashion are provided, wherein the leaf spring and the ratchet element form a ratchet connection both in the activation position and in the release position of the shaft;

(iii) the parking lock gearwheel has teeth and tooth gaps which alternate in the circumferential direction, wherein the teeth have a saddle-roof-shaped head contour;

(iv) the latch and/or the pawl have at least one recess for reducing the moment of inertia; and/or

(v) the latch and the pawl interact in the latching position of the latch in such a way that self-locking occurs between the latch and the pawl.

These individual features contribute overall to a parking lock which is easy to mount and activate and which reliably makes available a large securing force in the locking position, and in the case of misuse prevents undesired vibrations in the drive train and relatively severe damage.

In order to reliably ensure a large securing force in the locking position of the parking lock, the pawl preferably has an undercut into which the latch engages in its latching position. This gives rise to what is referred to as self-locking between the latch and the pawl and means, in other words, that the parking lock, to be more precise the pawl of the parking lock, can be released from the latching position into the unlatching position only by active pivoting of the latch. On the other hand, the parking lock cannot be released by parking lock gearwheel torque acting on the pawl, since the pawl cannot be pivoted into its release position when such loading occurs, owing to the undercut and the resulting self-locking.

Other objects, advantages and novel features of the present invention will become apparent from the following detailed description of one or more preferred embodiments when considered in conjunction with the accompanying drawing.

### BRIEF DESCRIPTION OF THE DRAWING

The single Figure is a perspective view of a parking lock for motor vehicles, in particular for motor vehicles having an automatic transmission, an automated transmission or an electric drive, according to an exemplary embodiment of the invention.

### DETAILED DESCRIPTION OF THE DRAWING

The single figure shows a parking lock 10 for motor vehicles, in particular for motor vehicles which have an automatic transmission, an automated transmission or an electric drive. The parking lock includes an activation device 12 with a shaft 14 for coupling to an actuator 16. The shaft 14 can be pivoted about an activation axis A between an activation position and a release position illustrated in the figure. A latching device 18 is coupled to the activation device 12 and has a latch 20 which is pivotable about the activation axis A between a latching position and an unlatching position illustrated in the figure. A pawl 22 is pivotable about a pawl bearing axis B between a locking position illustrated in the figure and a release position. And, a parking lock gearwheel 24 is rotatable about a parking lock axis C and is coupled to a motor vehicle wheel in a rotationally fixed fashion.

In the locking position, a locking tooth 26 of the pawl 22 engages in the parking lock gearwheel 24 in such a way that rotation of the parking lock gearwheel 24 about the parking lock axis C is blocked. On the other hand, in the release position of the pawl 22 the locking tooth 26 is spaced apart from the parking lock gearwheel 24, with the result that rotation of the parking lock gearwheel 24 about the parking lock axis C is released. In addition, a limb spring 28, which pushes the pawl 22 into its release position, is provided in the region of the pawl bearing axis B.

As it pivots into its activation position, the shaft 14 of the activation device 12 pushes the latch 20 into its latching position, wherein as it pivots into its latching position the latch 20 in turn pushes the pawl 22 into its locking position counter to the spring force of the limb spring 28. The latch 20 is mounted here on the shaft 14 so as to be pivotable to a limited degree, wherein a limb spring 30, which pushes the latch 20 relative to the shaft 14 with a spring force acting in the direction of the latching position, is arranged between the shaft 14 and the latch 20.

In contrast, in the release position of the shaft 14, the latch 20 is held in its unlatching position, wherein the pawl 22 is released in this unlatching position and moves into its release position owing to the spring loading by the limb spring 28.

Since the parking lock 10 which is illustrated in the figure corresponds largely in terms of its general design and its general functional principle to the parking lock according to DE 10 2010 027 826 A1, reference is made in this respect specifically to the description in DE 10 2010 0217 826 A1, whose contents are incorporated by reference herein. Only differences and advantages of the parking lock 10 are explored in more detail in the following text.

For example, in its latching position, the latch 20 interacts with the pawl 22 in such a way that self-locking occurs between the latch 20 and the pawl 22. For this purpose, an undercut 32, into which the latch 20 engages in its latching position, is formed in the pawl 22. This means that during its movement from the latching position into the unlatching position, the latch 20 firstly pivots the pawl 22 counter to the spring force of the limb spring 28 toward the parking lock gearwheel 24 before it then releases the pawl 22, with the result that the latter is moved in a spring-loaded fashion away from the parking lock gearwheel 24 and into its release position. Therefore, the undercut 32 of the pawl 22 easily ensures a particularly large securing force of the activated parking lock 10.

The parking lock gearwheel 24 has teeth 34 and tooth gaps 36 which alternate in the circumferential direction, wherein in the locking position of the pawl 22 the locking tooth 26 engages in one of the tooth gaps 36 in order to block rotation of the parking lock gearwheel 24 about the parking lock axis C. In this case, the parking lock 10 is activated, wherein the rotationally fixed coupling between a vehicle wheel and the blocked parking lock gearwheel 24 reliably prevents the motor vehicle from rolling away.

According to the figure, the teeth 34 of the parking lock gearwheel 24 have a saddle-roof-shaped head contour 38 on their radial outer side. Therefore, the head contour 38 of each tooth 34 comprises two oblique faces 40 which adjoin one another and which enclose an angle α of 155°≦α≦175°, in particular α≈165°.

If the parking lock 10 is activated in what is referred to as a “case of misuse” at vehicle speeds above a crawling speed, the head contour 38 prevents relatively severe damage to the vehicle transmission and/or the parking lock 10. Owing to the head contour 38, the pawl 22 is in fact deflected in a particularly low-impact fashion by the quickly rotating parking lock gearwheel 24 which is coupled in a rotationally fixed fashion to the vehicle wheel, and reliably prevents the locking tooth 26 from engaging in the tooth gaps 36.

In order to prevent undesirably strong vibrations in the drive train of the motor vehicle in the case of misuse, it has also proven advantageous to minimize the moments of inertia of the latch 20 and of the pawl 22 as a result of which, in the case of misuse, the energy which is introduced into the vehicle transmission via the parking lock gearwheel 24 is also drastically reduced.

In the present case, the latch 20 and the pawl 22 have recesses 42 in order to reduce the moment of inertia. These recesses 42 can be embodied, for example, as milled portions, as illustrated on the latch 20, or as through-bores parallel to the pawl bearing axis B, as illustrated on the pawl 22.

In order to mount the actuator 16 on the activation device 12 of the parking lock 10, an axial end 44 of the shaft 14 is embodied as a multi-toothed or polygonal element. Such a positively locking and essentially rotationally fixed multi-tooth or polygonal connection permits advantageous, positionally defined mounting of the actuator 16 on the parking lock 10 at low cost.

According to the figure, a leaf spring 46 and a ratchet element 48 which is connected to the shaft 14 in a rotationally fixed fashion are also provided, wherein the leaf spring 46 and the ratchet element 48 form a ratchet connection both in the activation position and in the release position of the shaft 14. In this context, the leaf spring 46 has an attachment end 50 for mounting the leaf spring 46 in such a way that it is fixed to the bodywork, and an opposite ratchet end 52 which is pushed against the ratchet element 48 by a spring section 54 of the leaf spring 46. The ratchet element 48 has a recess 56 which is assigned to the activation position, and a recess 58 which is assigned to the release position, with the result that the ratchet end 52 of the leaf spring 46 engages in one of the recesses 56, 58 in both positions of the shaft 14, and forms a ratchet connection.

Adjacent to the attachment end 50, the leaf spring 46 has the essentially planar spring section 54 which, at the ratchet end 52 of the leaf spring 46, is bent over toward the ratchet element 48, in particular rolled up, and forms a ratchet projection 60.

In the present case, the leaf spring 46 therefore acts as a ratchet spring whose ratchet projection 60 clips into one of the recesses 56, 58 both in the activation position and in the release position of the shaft 14, in order to secure the shaft 14.

According to the figure, the ratchet element 48 is a ratchet plate which extends perpendicularly with respect to the activation axis A and has, in each case, a notch as recesses 56, 58, into which the ratchet projection 60 of the leaf spring 46 can engage.

In this way, the parking lock 10 can be activated with particularly low loading of the actuator 16, which has a positive effect on the service life and energy consumption thereof.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A parking lock for a motor vehicle having an automatic transmission, an automated transmission or an electric drive, comprising:
an activation device with a shaft for coupling to an actuator, wherein the shaft is pivotable about an activation axis between an activation position and a release position;
a latching device coupled to the activation device and having a latch which is pivotable about the activation axis between a latching position and an unlatching position;
a pawl which is pivotable about a pawl bearing axis between a locking position and a release position; and
a parking lock gearwheel which is rotatable about a parking lock axis and is coupled to a motor vehicle wheel;
wherein, in a locking position, the pawl engages in the parking lock gearwheel such that rotation of the parking lock gearwheel about the parking lock axis is blocked, and in a release position, the pawl is spaced apart from the parking lock gearwheel, with a result that rotation of the parking lock gearwheel about the parking lock axis is released,
wherein, in the activation position of the shaft, the shaft of the activation device pushes the latch into the latching position, and the latch pushes the pawl into the locking position,
wherein, in the release position of the shaft, the latch assumes an unlatching position in which the pawl is released, and
wherein the parking lock comprises one or more of the following features:
(i) an axial end of the shaft is configured to connect in a positively locking fashion to the actuator as a multi-toothed or polygonal element;
(ii) a leaf spring and a ratchet element which is connected to the shaft in a rotationally fixed fashion are provided, wherein the leaf spring and the ratchet element form a ratchet connection both in the activation position and in the release position of the shaft;
(iii) the parking lock gearwheel has teeth and tooth gaps which alternate in the circumferential direction, wherein the teeth have a saddle-roof-shaped head contour;
(iv) the latch and/or the pawl have at least one recess for reducing a moment of inertia; and
(v) the latch and the pawl interact in the latching position of the latch such that self-locking occurs between the latch and the pawl.

2. The parking lock according to claim 1, wherein the pawl is spring-loaded in the release position.

3. The parking lock according to claim 1, wherein:
the leaf spring and the ratchet element which is connected to the shaft in a rotationally fixed fashion are provided,
the leaf spring has an attachment end and an opposite ratchet end which is pushed against the ratchet element, and
the ratchet element has a recess which is assigned to the release position and a recess which is assigned to the activation position, with the result that the ratchet end of the leaf spring engages in one of the recesses and forms a ratchet connection, both in the activation position and in the release position of the shaft.

4. The parking lock according to claim 2, wherein:
the leaf spring and the ratchet element which is connected to the shaft in a rotationally fixed fashion are provided,
the leaf spring has an attachment end and an opposite ratchet end which is pushed against the ratchet element, and
the ratchet element has a recess which is assigned to the release position and a recess which is assigned to the activation position, with the result that the ratchet end of the leaf spring engages in one of the recesses and forms a ratchet connection, both in the activation position and in the release position of the shaft.

5. The parking lock according to claim 3, wherein the leaf spring has an essentially planar spring section which is bent over toward the ratchet element at the ratchet end of the leaf spring and forms a ratchet projection.

6. The parking lock according to claim 4, wherein the leaf spring has an essentially planar spring section which is bent over toward the ratchet element at the ratchet end of the leaf spring and forms a ratchet projection.

7. The parking lock according to claim 1, wherein:
the parking lock gearwheel has teeth and tooth gaps which alternate in the circumferential direction,
each tooth has a saddle-roof-shaped head contour in a cross section of the parking lock gearwheel, and
two oblique faces enclose an angle (α) of 155°≦α≦175°.

8. The parking lock according to claim 7, wherein the angle (α) is approximately 165°.

9. The parking lock according to claim 4, wherein:
the parking lock gearwheel has teeth and tooth gaps which alternate in the circumferential direction,
each tooth has a saddle-roof-shaped head contour in a cross section of the parking lock gearwheel, and
two oblique faces enclose an angle (α) of 155°≦α≦175°.

10. The parking lock according to claim 1, wherein the latch and/or the pawl have the at least one recess, embodied as a through-bore parallel to the pawl bearing axis, for reducing the moment of inertia.

11. The parking lock according to claim 4, wherein the latch and/or the pawl have the at least one recess, embodied as a through-bore parallel to the pawl bearing axis, for reducing the moment of inertia.

12. The parking lock according to claim 7, wherein the latch and/or the pawl have the at least one recess, embodied as a through-bore parallel to the pawl bearing axis, for reducing the moment of inertia.

13. The parking lock according to claim 1, wherein the pawl has an undercut into which the latch engages in the latching position.

14. The parking lock according to claim 4, wherein the pawl has an undercut into which the latch engages in the latching position.

15. The parking lock according to claim 7, wherein the pawl has an undercut into which the latch engages in the latching position.
